(19) United States
(12) Patent Application Publication
(10) Pub. No.: US 2022/0007891 A1
(43) Pub. Date: Jan. 13, 2022

(54) A Method For Deep Frying A Food Product, As Well As A Deep Frying Device

(71) Applicants: Petrus Wessel Van Den Bosch, Woerden (NL); D.N.A. MACHINEBOUW B.V., Woerden (NL)

(72) Inventor: Petrus Wessel Van Den Bosch, Woerden (NL)

(73) Assignees: D.N.A. MACHINEBOUW B.V., Woerden (NL); Petrus Wessel Van Den Bosch, Woerden (NL)

(21) Appl. No.: 17/294,160

(22) PCT Filed: Nov. 12, 2019
(86) PCT No.: PCT/NL2019/050739

§ 371 Date: May 14, 2021

(30) Foreign Application Priority Data
Nov. 16, 2018 (NL) 2022010

(51) Int. Cl. A47J 37/12; A23L 5/10; F23M 9/10

(52) U.S. Cl. CPC A47J 37/1247; A47J 37/129; F23M 2900/05005; F23M 9/10; A23V 2002/00; A23L 5/11

(57) ABSTRACT

Method and a deep frying device for deep frying a food product in a deep frying device, wherein the deep frying device comprises a container for fat. For reducing the chances of damaging the deep frying device by the deep frying and increasing the availability, use is made of a deep frying device comprising a pipe section for hot flue gas which protrudes into the lumen of the container but is not connected to an opposite wall. The pipe section comprises—a plurality of supply pipes for the relatively hot flue gas, and—at least one outlet pipe for the relatively cold flue gas coming from the plurality of supply pipes.

The present invention relates to a method for deep frying a food product in a deep frying device, wherein the deep frying device

is arranged for heating fat using flue gas, and
comprises a container, which container comprises wall sections, which wall sections comprise at least
a bottom wall section,
a front wall section,
a rear wall section, and
two upright longitudinal wall sections which interconnect said front wall section and rear wall section, and the wall sections define a lumen of the container;
   wherein the container contains a fat; and
   wherein, in order to deep fry the food product, the fat is heated using a burner, and the food product is deep fried in the heated fat.

Such a method is well known in the art for making fries, snacks and the like. During deep frying heat must be supplied. Firstly, in order to raise the temperature of the food product that mostly comes from the refrigerator or is at room temperature. Secondly, because during deep frying water vapour escapes from the food product, which costs a lot of energy.

For deep frying a container with fat is used. The container is usually heated at the bottom with a burner wherein the combustion gases flow from a first side of the container along the bottom side of the container to an opposite second side of the container for releasing heat to the container and thereby to the fat. A problem is that the temperature of the bottom of the container may become hot to such an extent that crumbs or the like of the food product that end up on the bottom will pyrolyse there and form harmful substances which may end up in the food product.

A deep frying device is known which comprises a couple of channels, which channels connect a first upright wall and an opposite second upright wall and are interconnected at the second upright wall. Herewith, combustion gases, after having passed the bottom, flow from the first upright wall via a first channel to the second upright wall and from the second upright wall via the second channel back again to the first upright wall where the combustion gases are discharged. The enlarged heat exchanging surface ensures that the heat difference between the heat supplying surfaces and the fat can be smaller, thus reducing the chances of pyrolysis of fat and/or food particles coming from the food to be fried.

A problem with the known deep frying device is that, in case a repair is needed for example due to cracking, this will be very time consuming. This means that the operating time is shorter and thus there will also be a loss of turnover.

It is an object of the present invention to provide a method that can be used for deep frying effectively, but which method reduces wear of the frying device.

To this end, a method according to the preamble is characterized in that the container comprises a main wall section selected from
the bottom wall section,
the front wall section,
the rear wall section, and
an upright longitudinal wall section;
   the deep frying device comprises a heating section, wherein the heating section comprises
a wall unit, and
a pipe section;
   wherein the wall unit comprises an inlet for relatively hot flue gas and an outlet for relatively cold flue gas, and the pipe section protrudes from the main wall section into the lumen and is not rigidly connected to the other wall sections;
   and wherein the pipe section protruding into the lumen of the container comprises
at least one supply pipe for the relatively hot flue gas, and
at least one outlet pipe for the relatively cold flue gas coming from the at least one supply pipe;
   wherein for heating the fat hot flue gas is passed via the inlet of the wall unit through the pipe section and discharged via the outlet of the wall unit.

By deep frying using such a deep frying device the chances of damaging the deep frying device by deep frying are limited and an improved availability is achieved since the deep frying device will break down less quickly because of the daily changing temperatures.

Any contact between flames and the container and thus locally very high temperatures which can lead to pyrolysis, can be effectively avoided. Furthermore, it is possible to work with an enlarged heat exchanging surface without losing the ability to clean the inside of the surface of the container. Thanks to the enlarged heat exchanging surface, the fat can be heated quickly and will last a long time, also because pyrolysis is limited effectively.

The heat exchanging surface area of the heating section is preferably at least of the same size as the surface area of the bottom section, advantageously at least twice as big and more advantageously at least three times as big.

Preferably, the pipe section is not at all connected to the other wall sections and most preferably also not in contact therewith. In that case the wall unit (and more specifically the pipe section) has a free distal end.

According to a favourable embodiment, the main wall section is selected from
the bottom wall section,
the front wall section, and
an upright longitudinal wall section.

These have a better accessibility than the rear wall section, as a result of which replacement is easier. The main wall section is preferably the front wall section. Thus, an optimal accessibility is provided and the down time in case of a repair can be limited.

According to a favourable embodiment, the total of the cross sectional flow surface areas of the supply pipes is greater than the total cross sectional flow surface areas of the at least one outlet pipe.

A pipe for flue gas has an internal cross section and the surface area thereof is the cross sectional flow surface area of the pipe. With this favourable embodiment the hot flue gas flows through the supply pipes relatively slowly and can release heat well.

After it has cooled down it flows relatively quickly through the outlet pipe in order to be discharged, usually to a flue duct.

According to a favourable embodiment, the heating section has the form of a heating module which is detachably attached to the main wall section.

If the heat exchanging surface of the heating section shows a crack or has to be cleaned, the fat can be removed from the container and subsequently the heating section can be taken out quickly and easily. If so desired, the heating section can be replaced by another heating section as a result of which the deep frying device can be put into operation again immediately.

The heating module may for example be hung over the edge of the container.

According to a favourable embodiment, the main wall section comprises a through opening and the through opening of the main wall section is closed off with the wall unit.

Thus, inserting a basket with fries or other product to be deep fried is not hindered.

According to a favourable embodiment, a gasket is provided between the wall and the heating section.

The gasket usually comprises a temperature resistant and preferably resilient material.

According to a favourable embodiment, the gasket is a gasket that comprises graphite.

It has been found that this works well with the changing temperature circumstances that occur on a daily basis.

According to a favourable embodiment, the deep frying device contains a further inlet and a further outlet for guiding flue gas at the outside of a wall section, which further inlet is provided with a first connecting element and the outlet of the heating section is provided with a second connecting element for detachably connecting the outlet of the wall unit to the first connecting element.

Thus, an energy saving can be attained.

This favourable embodiment also makes it possible to discharge the flue gas at the back side or side of the deep frying device, as is common practice.

Advantageously, the deep frying device comprises a double wall comprising at least one of the wall sections as a wall, and the further inlet offers access for flue gas to the space between the walls of the double wall.

According to a favourable embodiment, at least one supply pipe of a plurality of supply pipes is provided with a plurality of channels provided transverse to the longitudinal direction of the supply pipe, which channels

extend from the outer wall of the supply pipe via the inside of the supply pipe to an opposite part of the outer wall of the supply pipe
comprise a first end situated relatively low and a second end situated relatively high in order to be able to pass fat from the lumen through the channel.

The channels enlarge the heat exchanging surface and fat heated by flue gas will rise in the channels and thus enable an even and quick heating.

Finally, the present invention relates to deep frying device, wherein the deep frying device is arranged for heating flue gas using fat and comprises a container, which container comprises wall sections, which wall sections comprise at least
a bottom wall section,
a front wall section,
a rear wall section,
two upright longitudinal wall sections which interconnect said front wall section and rear wall section,
   and the wall sections define a lumen of the container.

A problem with the known deep frying device is that in case a repair is needed, for instance when crack formation occurs, this is very time consuming. This means that the operating time will be less and thus implies a loss of turnover.

The present invention aims to provide a deep frying device having an improved availability.

To this end, deep frying device according to the preamble is characterized in that the container comprises a main wall section selected from
the bottom wall section,
the front wall section, and
an upright longitudinal wall section;
   wherein the heating section comprises
a wall unit, and
a pipe section;
   wherein the wall unit comprises an inlet for relatively hot flue gas and an outlet for relatively cold flue gas, and the pipe section protrudes from the main wall section into the lumen and is not rigidly connected to the other wall sections;
   and wherein the pipe section protruding into the lumen of the container comprises
at least one supply pipe for the relatively hot flue gas, and
at least one outlet pipe for the relatively cold flue gas coming from the at least one supply pipe.

Thus, a deep frying device is provided with which fat can be heated effectively while damage to the device by deep frying is limited.

According to a favourable embodiment, the main wall section is selected from
the bottom wall section,
the front wall section, and
an upright longitudinal wall section.

These have a better accessibility than the rear wall section, as a result of which replacement is easier. The main wall section is preferably the front wall section. Thus, an optimal accessibility is provided.

According to a favourable embodiment, the total of the cross sectional flow surface areas of the supply pipes is larger than the cross sectional flow surface areas of the outlet pipe.

A pipe for flue gas has an internal cross section and the surface area thereof is the cross sectional flow surface area. Thus, the hot flue gas flows through the supply pipes relatively slowly and can release heat well.

After it has cooled down it flows relatively quickly through the outlet pipe in order to be discharged, usually to a flue.

According to a favourable embodiment, the heating section has the form of a heating module which is detachably attached to the main wall section.

If the heat exchanging surface shows a crack or has to be cleaned, the fat can be removed from the container and subsequently the heating section can be taken out quickly and easily. If so desired, the heating section can be replaced by another heating section as a result of which the deep frying device can be put into operation again immediately.

The heating module may for example be hung over the edge of the container.

According to a favourable embodiment, the main wall section comprises a through opening and the through opening of the main wall section is closed off with the wall unit.

Thus, inserting a basket with fries or other product to be deep fried is not hindered.

The present invention also relates to a deep frying device with the measures of the subclaims described for the method only or in any combination, which for the sake of brevity will not be repeated.

According to a favourable embodiment, between the wall and the heating section a gasket is provided.

The gasket usually comprises a temperature resistant and preferably resilient material.

According to a favourable embodiment, the gasket is a gasket that comprises graphite.

It has been found that this works well with the changing temperature circumstances that occur on a daily basis.

According to a favourable embodiment, at least one supply pipe of a plurality of supply pipes is provided with a plurality of channels provided transverse to the longitudinal direction of the supply pipe, which channels

extend from the outer wall of the supply pipe via the inside of the supply pipe to an opposite part of the outer wall of the supply pipe
comprise a first end situated relatively low and a second end situated relatively high in order to be able to pass fat from the lumen through the channel.

The channels enlarge the heat exchanging surface and fat heated by flue gas will rise in the channels and thus enable an even and quick heating. Preferably, all supply pipes will be provided with such channels.

Advantageously, the outlet pipe is also provided with corresponding channels.

The present invention will now be illustrated with reference to the drawing where

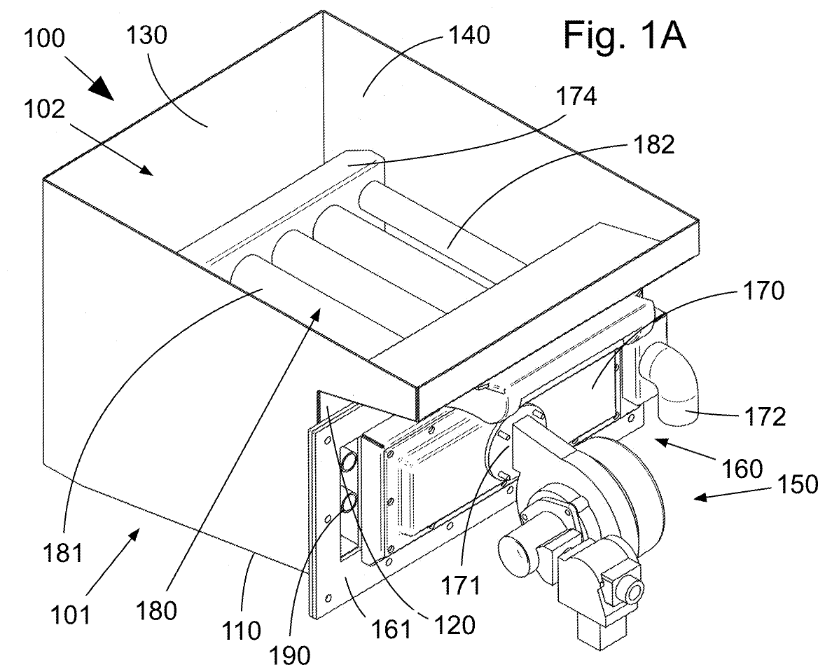

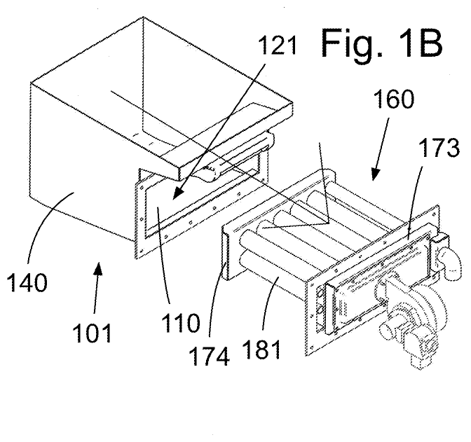

FIG. 1A shows a perspective view of a deep frying device according to the invention;

FIG. 1B shows an explosion view of the deep frying device of FIG. 1A;

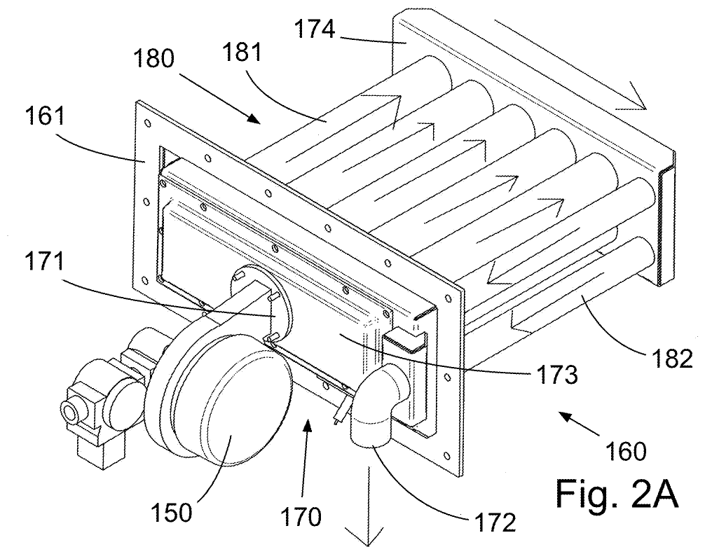

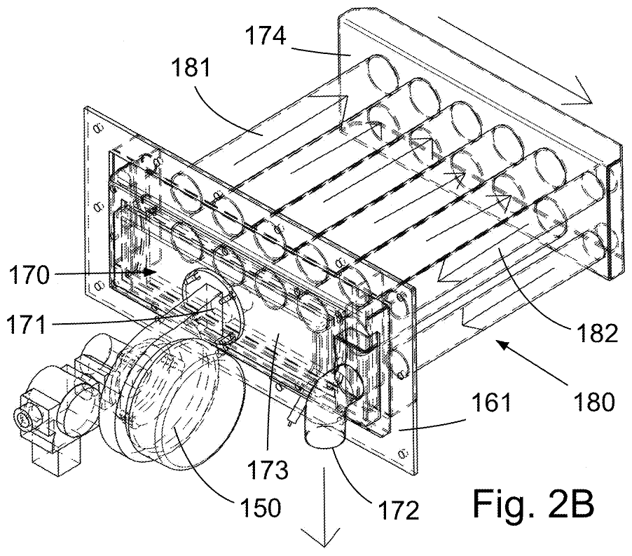

FIG. 2A and FIG. 2B show a perspective view of a heating module of the deep frying device of FIG. 1B; and

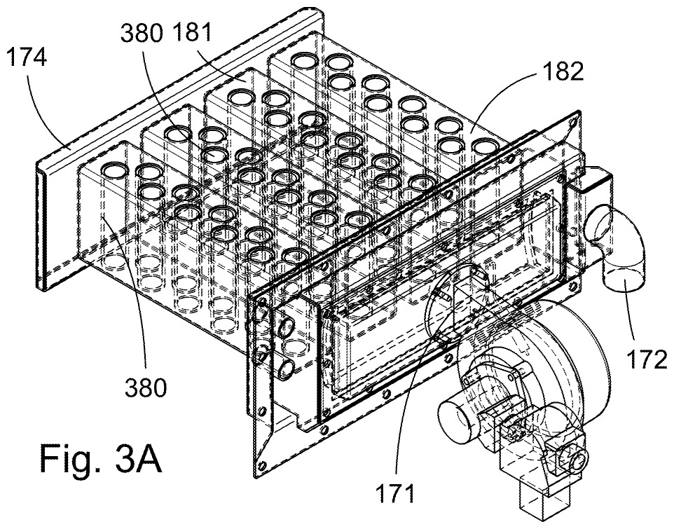

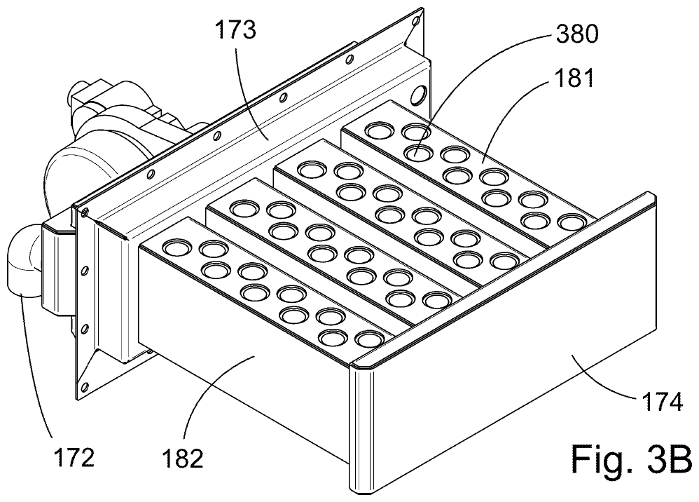

FIG. 3A and FIG. 3B show a perspective front view and rear view of an alternative heating section for a deep frying device.

For deep frying a food product with the method according to the invention use is made of a deep frying device 100 (FIG. 1A), wherein the deep frying device 100 comprises a container 101, which container comprises wall sections, which wall sections comprise at least
a bottom wall section 110,
a front wall section 120,
a rear wall section 130,
two upright longitudinal wall sections 140 which interconnect said front wall section 120 and rear wall section 130. The container 101 defines a lumen 102 in which for deep frying fat (also including oil; a fat that is liquid at room temperature) is present.

The device 100 further comprises a burner 150 with which a fuel such as gas is burned, and the hot flue gases are used for heating the fat in order to deep fry therewith.

The deep frying device 100 comprises a main wall section selected from
the bottom wall section 110,
the front wall section 120, and
an upright longitudinal wall section 140.

The deep frying device 100 further comprises a heating section 160, which heating section 160 comprises
a wall unit 170, and
a pipe section 180.

The wall unit 170 comprises an inlet 171 for relatively hot flue gas and an outlet 172 for relatively cold flue gas. The inlet 171 is connected to the burner 150 in order to lead hot flue gases through the pipe section 180 and discharge them via the outlet 172.

The burner 150 is a venturi burner, as is known from a central heating installation.

The pipe section 180 protrudes from the main wall section into the lumen 102 but is not connected fixedly to the other wall sections.

The pipe section 180 which protrudes into the lumen of the container comprises
a plurality of supply pipes 181 for the relatively hot flue gas, and
at least one outlet pipe 182 for the relatively cold flue gas coming from

the plurality of supply pipes 181.

The flue gas is distributed from an upstream distribution chamber 173 and collected in the downstream collection chamber 174 from which it is discharged via the outlet pipe 182 via the outlet 172. Prior to use, the outlet pipe 182 is connected to a flue (not shown) of the kitchen or other room in which the deep frying takes place.

With the embodiment of the deep frying device 100 as discussed here, the heating section 160 has the form of a heating module 160, which can be attached to the main wall section (here front wall section 120). To this end, the heating section 160 comprises a flange 161 which can be attached to the front wall section 120 using bolts and protrudes into the front wall section into the lumen 102 via a through opening 121.

The module may be equipped with one or more temperature sensors 190 for controlling the burner 150.

For sealing use is made of a graphite-comprising gasket between the flange 161 and the front wall section 120.

FIG. 2A and FIG. 2B (with hidden lines) show a perspective view of a heating module of the deep frying device 100 of FIG. 1B.

The heating module 160 also comprises the burner 150, whereby if a repair is needed the broken down heating module 160 can be replaced quickly by another one.

FIG. 3A and FIG. 3B show a perspective front view (indicated with hidden lines) and rear view of an alternative heating module 160 for a deep frying device 100. With this embodiment the pipes for flue gas (supply pipes 181 and outlet pipe 182) are provided with channels in the form of small vertical tubes 380 which provide for surface area enlargement and for circulation of the liquid fat in the container.

1. A method for deep frying a food product in a deep frying device, wherein the deep frying device:
is arranged for heating fat using flue gas, and
comprises a container, which container comprises wall sections, which wall sections comprise at least:
a bottom wall section,
a front wall section,
a rear wall section, and
two upright longitudinal wall sections which interconnect said front wall section and rear wall section, and the wall sections define a lumen of the container;
wherein the container contains a fat; and
wherein, in order to deep fry the food product, the fat is heated using a burner, and the food product is deep fried in the heated fat; characterized in that the container comprises a main wall section selected from:
the bottom wall section,
the front wall section,
the rear wall section, and
an upright longitudinal wall section;
the deep frying device comprises a heating section, wherein the heating section comprises
a wall unit, and
a pipe section;
wherein the wall unit comprises an inlet for relatively hot flue gas and an outlet for relatively cold flue gas, and the pipe section protrudes from the main wall section into the lumen and is not rigidly connected to the other wall sections;
and wherein the pipe section protruding into the lumen of the container comprises
at least one supply pipe for the relatively hot flue gas, and
at least one outlet pipe for the relatively cold flue gas coming from the at least one supply pipe;
wherein for heating the fat hot flue gas is passed via the inlet of the wall unit through the pipe section and discharged via the outlet of the wall unit.

2. The method according to claim 1, wherein the main wall section is selected from
the bottom wall section,
the front wall section, and
an upright longitudinal wall section.

3. The method according to claim 1, wherein the total of the cross sectional flow surface areas of the supply pipes is greater than the total cross sectional flow surface areas of the at least one outlet pipe.

4. The method according to claim 1, wherein the heating section has the form of a heating module which is detachably attached to the main wall section.

5. The method according to claim 4, wherein the main wall section comprises a through opening and the through opening of the main wall section is closed off with the wall unit.

6. The method according to claim 4, wherein a gasket is provided between the wall and the heating section.

7. The method according to claim 6, wherein the gasket comprises graphite.

8. The method according to claim 1, wherein the deep frying device contains a further inlet and a further outlet for guiding flue gas at the outside of a wall section, which further inlet is provided with a first connecting element and the outlet of the heating section is provided with a second connecting element for detachably connecting the outlet of the wall unit to the first connecting element.

9. The method according to claim 1, wherein at least one supply pipe of a plurality of supply pipes is provided with a plurality of channels provided transverse to the longitudinal direction of the supply pipe, which channels:
extend from the outer wall of the supply pipe via the inside of the supply pipe to an opposite part of the outer wall of the supply pipe; and
comprise a first end situated relatively low and a second end situated relatively high in order to be able to pass fat from the lumen through the channel.

10. A deep frying device, wherein the deep frying device is arranged for heating flue gas using fat and comprises a container, which container comprises wall sections, which wall sections comprise at least
a bottom wall section,
a front wall section,
a rear wall section,
two upright longitudinal wall sections which interconnect said front wall section and rear wall section,
and the wall sections define a lumen of the container;
characterized in that the container comprises a main wall section selected from:
the bottom wall section,
the front wall section, and
an upright longitudinal wall section;
wherein the heating section comprises:
a wall unit, and
a pipe section;
wherein the wall unit comprises an inlet for relatively hot flue gas and an outlet for relatively cold flue gas, and the pipe section protrudes from the main wall section into the lumen and is not rigidly connected to the other wall sections;
and wherein the pipe section protruding into the lumen of the container comprises
at least one supply pipe for the relatively hot flue gas, and
at least one outlet pipe for the relatively cold flue gas coming from the at least one supply pipe.

11. The deep frying device according to claim 10, wherein the main wall section is selected from:
the bottom wall section,
the front wall section, and
an upright longitudinal wall section.

12. The deep frying device according to claim 10, wherein the total of the cross sectional flow surface areas of the supply pipes is larger than the cross sectional flow surface areas of the outlet pipe.

13. The deep frying device according to claim 10, wherein the heating section has the form of a heating module which is detachably attached to the main wall section.

14. The deep frying device according to claim 13, wherein the main wall section comprises a through opening and the through opening of the main wall section is closed off with the wall unit (170).

15. The deep frying device according to claim 13, wherein between the wall and the heating section a gasket is provided.

16. The deep frying device according to claim 10 to 15, wherein the gasket comprises graphite.

17. The deep frying device according to claim 10, wherein at least one supply pipe of a plurality of supply pipes is provided with a plurality of channels provided transverse to the longitudinal direction of the supply pipe, which channels:
extend from the outer wall of the supply pipe via the inside of the supply pipe to an opposite part of the outer wall of the supply pipe, and
comprise a first end situated relatively low and a second end situated relatively high in order to be able to pass fat from the lumen through the channel.
